(19) United States
(12) Patent Application Publication
(10) Pub. No.: US 2005/0147130 A1
(43) Pub. Date: Jul. 7, 2005

(54) Priority based synchronization of data in a personal area network

(75) Inventors: Roger A. Hurwitz, Portland, OR (US); Marion H. Shimoda, Aloha, OR (US); Thomas M. Cronin, Hillsboro, OR (US); Rajesh P. Banginwar, Hillsboro, OR (US); Travis T. Shultz, Hillsboro, OR (US)

Correspondence Address: VENABLE LLP, P.O. BOX 34385, WASHINGTON, DC, 20435-9998, US

(73) Assignee: Intel Corporation, Santa Clara, CA (US)

(21) Appl. No.: 10/743,047

(22) Filed: Dec. 23, 2003

(51) Int. Cl. H04J 3/06

(52) U.S. Cl. 370/503

(57) ABSTRACT

Priority-based data synchronization may be used to achieve improved flexibility and functionality.

### BACKGROUND OF THE INVENTION

Users of personal information manager (PIM) mobile devices such as, e.g., notebook, tablet and handheld personal computers (PCs), and personal digital assistants (PDAs), often have the need to synchronize data contained on the mobile devices with a master version of the data, often stored on a desktop computer or on a server. Typically, a synchronization operation involves the user connecting the mobile device to the master device with a cable or through a wireless connection. A synchronization application program then proceeds through a series of synchronization tasks in a fixed order. For example, the synchronization application might synchronize a calendar, then a contact list, then a task list, then a notepad, then an expense record and finally an e-mail in-box.

Conventionally, if any one of the synchronization tasks fails or is interrupted, the entire synchronization process must restart. Synchronization failure is rare for wired connections, but wireless connections are prone to more frequent interruptions if the mobile device is moved due to the transient and intermittent nature of the wireless connection. Additionally, the user cannot choose the ordering of the synchronization tasks. If, e.g., in the order presented above, the user only cares that the e-mail inbox be synchronized, the user must conventionally wait for all of the other synchronization tasks to be completed first before the user's e-mail is synchronized.

### BRIEF DESCRIPTION OF THE DRAWINGS

Various exemplary features and advantages of the invention will be apparent from the following, more particular description of exemplary embodiments of the present invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of a mobile device and base device prioritized synchronization system according to an exemplary embodiment of the present invention;

FIG. 2 depicts an exemplary embodiment of a flow diagram illustrating an exemplary process of prioritized synchronization according to an exemplary embodiment of the present invention;

FIG. 3 depicts an exemplary embodiment of a mobile device illustrating a user specified synchronization priority according to an exemplary embodiment of the present invention; and

FIG. 4 depicts an exemplary embodiment of a computer system that may be used in the mobile or base devices according to an exemplary embodiment of the present invention.

### DETAILED DESCRIPTION OF EXEMPLARY EMBODIMENTS OF THE PRESENT INVENTION

A preferred embodiment of the invention is discussed in detail below. While specific exemplary embodiments may be discussed, it should be understood that this is done for illustration purposes only. A person skilled in the relevant art will recognize that other components and configurations may be used without parting from the spirit and scope of the invention.

An exemplary embodiment of the present invention may include a system, method, and computer program product for priority-based synchronization of personal information manager (PIM) items that may be user-defined. The system may allow the user to assign the order in which PIM items may be synchronized. The system may further allow a synchronization process to be interrupted before all synchronization tasks have been completed. The process of synchronizing data may include, e.g., updating data to or replicating from a common database, and/or merging data from two sources including resolving any conflicts.

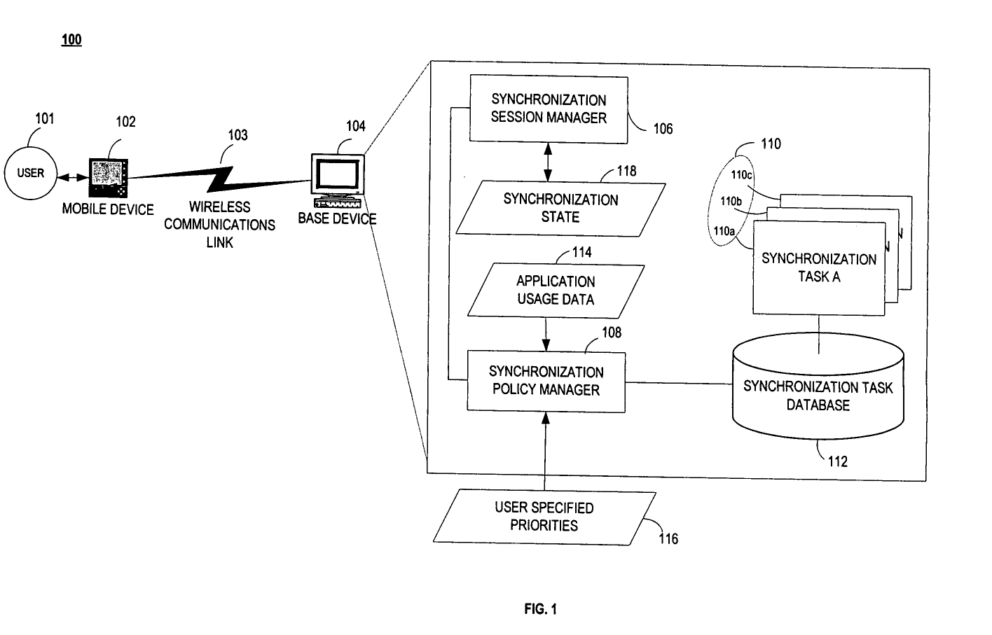

FIG. 1 depicts an exemplary embodiment of a diagram 100 illustrating a prioritized synchronization system including a mobile device 102 in use by a user 101 to synchronize data on the mobile device 102 with a base device 104 in an exemplary embodiment of the present invention. Using the exemplary prioritized synchronization system may include, e.g., (but not limited to) receiving one or more synchronization priority assignments at the mobile device 102, the base device 104, or another device (not shown). Mobile device 102 as shown may be coupled to base device 104 over an exemplary wireless communication link 103. In an exemplary embodiment, the mobile device 102 may be wirelessly communicating with base device 104. In an exemplary embodiment, the mobile device 102 may communicate with the base device 104 using any of a number of well known wireless communications protocols, networks and technologies such as, e.g., (but not limited to) an Infrared Data Association (IrDA)-compliant wireless technology, or a radio frequency (RF) technology such as, e.g., (but not limited to) a Bluetooth-compliant wireless technology, an Institute of Electrical and Electronics Engineers (IEEE) standard 802.11-compliant wireless local area network (LAN) (discussed further below), a shared wireless access protocol (SWAP)-compliant wireless technology, a wireless fidelity (Wi-Fi)-compliant wireless technology, and an ultra wide band (UWB) wireless technology network, etc. Although mobile device 102 and base device 104 may be described as coupled to one another, the devices 102, 104 need not be directly connected to one another, and may instead by coupled by any of various conventional physical network technologies such as, e.g., (but not limited to) routers, bridges, gateways, transceivers, antennae and cables, etc.

The mobile device 102 may be a communications device or computing device such as, e.g., (but not limited to) a tablet personal computer (PC), a handheld PC, a subnotebook PC a notebook PC, a laptop PC, a personal digital assistant (PDA), or other device such as a desktop PC or workstation, etc. Mobile device 102 may include any of various operating systems (OS) upon which application software programs may execute. Exemplary operating systems that may be used on such mobile devices 102 may include, e.g., (but not limited to) a WINDOWS MOBILE™ for Pocket PCs operating system, available from MICROSOFT® CORPORATION of Redmond, Wash., U.S.A. Although mobile device 102 in an exemplary embodiment may be described as mobile, the device need not be mobile, and may actually be stationary. The base device 104 may be another mobile device, a desktop computer, or some other source of data that may be synchronized with the data on the mobile device 102. The base device 104 as depicted in the exemplary embodiment of diagram 100 may include, e.g., (but not limited to) a synchronization session manager 106, a synchronization policy manager 108, one or more synchronization tasks A 110a, B 110b, C 110c (collectively referred to as synchronization tasks 110), and a synchronization task database 112, etc.

Synchronization tasks 110 in an exemplary embodiment may include, e.g., (but not limited to) the individual synchronization transactions between applications on separate mobile and base devices 102, 104. For example, (but not limited to) coordinating data between a calendar application on an exemplary wireless PDA mobile device 102 and a calendar application on an exemplary desktop base device 104 is an example of a synchronization task 110. Synchronization tasks 110 may be defined or created at different levels of granularity. A first exemplary level of granularity of synchronization task 110 might be all calendar transactions. A second exemplary level of more detailed granularity could divide calendar transactions tasks into sub-categories based on, e.g., (but not limited to) calendar transactions types such as, e.g., appointment adds, deletes, and changes, etc. The smaller the granularity of specificity of synchronization task 110, the more robust the prioritization of synchronization tasks may be possible. Further, in an exemplary embodiment, an elemental level of a synchronization task may be referred to as a synchronization item (not shown). The synchronization item may correspond to a pair of data elements (such as, e.g., (but not limited to) databases, data records, or data fields, etc.), one element of the pair of data elements being a data element on mobile device 102, and a second element of the pair of data elements being a data element on base device 104.

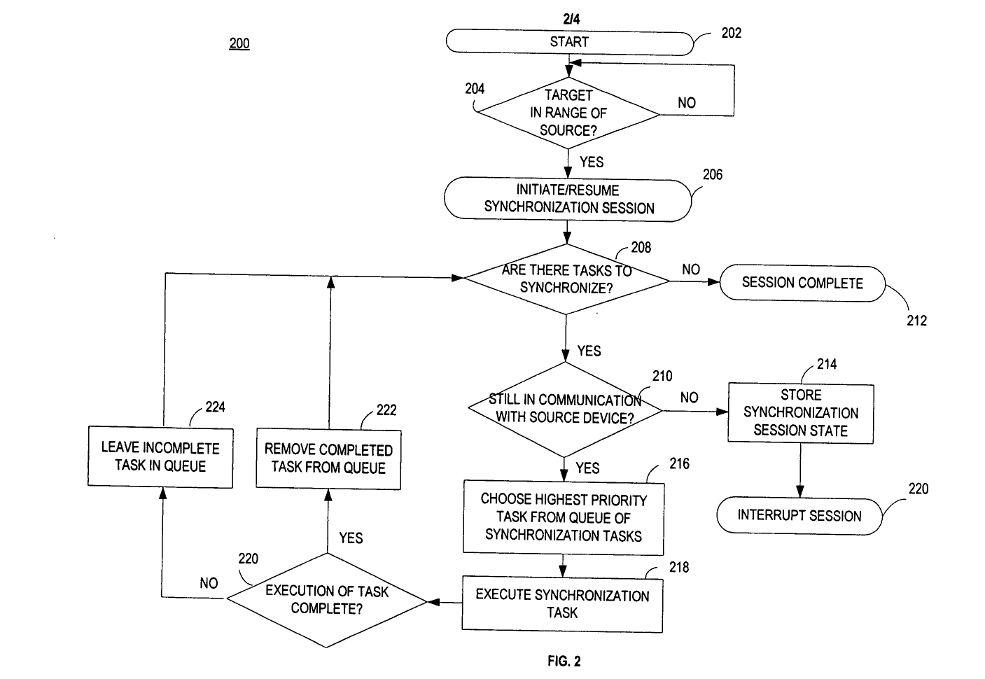

The synchronization session manager 106 may execute the synchronization tasks 110 in an order of priority assigned by the synchronization policy manager 108. The synchronization session manager 106 may be started manually by user 101 (who may be a user of mobile device 102, base device 104, or both devices 102, 104, etc.), or automatically by an event, such as, e.g., (but not limited to) when the mobile device 102 comes within a range of the base device 104 (as described further below with reference to flow diagram 200 of FIG. 2), etc. The synchronization session manager 106 may execute on the mobile device 102, base device 104, or another device (not shown).

The synchronization policy manager 108 may assign synchronization priorities to the synchronization tasks 110. In an exemplary embodiment, the synchronization priorities may be assigned according to implicit, or explicit factors. Briefly, an exemplary, but not limiting, implicit factor may include prioritization based on application usage frequency. An exemplary, but not limiting explicit factor might include a user specified order of priority. Of course other factors may be used. Generally, exemplary explicit factors may include a factor that may specify a priority directly, i.e., a specified priority. Exemplary implicit factors may include a factor that may derive a priority indirectly from, e.g., other factors. Of course, a combination of implicit and explicit factors may also be used to assign synchronization priorities to synchronization tasks 110. The synchronization policy manager 108 may execute on the mobile device 102, base device 104, or another device (not shown).

The synchronization policy manager 108 may use application usage data 114 as shown in diagram 100 to implicitly determine which applications may be most often used by the user and to set the synchronization tasks 110 related to that application to have the highest priority. For example, (but not limited to) if the application usage data 114 indicates that a calendar application is used the most on the mobile device 102, then the synchronization policy manager 108 may set calendar-related synchronization tasks 110 to have the highest priority. Another implicit prioritization may relate to a type of data. For example, assuming use of a detailed level of synchronization task granularity, then, e.g., (but not limited to) all electronic mail (e-mail), e.g., might be divided into separate different categories such as, e.g., (but not limited to) unopened e-mail, new e-mail, e-mail including hypertext transfer protocol (http) information, e-mail from specific users, e-mail containing no attachments, internal company e-mail, e-mail from a given domain, etc., corresponding to different synchronization tasks 110, and then each different synchronization task 110 could be assigned a different synchronization prioritization, etc. For example, (but not limited to) internal company e-mail could be set to a lowest relative priority level. Synchronization priority levels may be derived from, e.g., (but not limited to) other tags, network priority indication, or indications of priority, such as, e.g., (but not limited to) quality of service levels, type of service (TOS) indications, differentiated services (DIFFSERV) levels, virtual private network (VPN) tags, etc.

Thus, in an exemplary embodiment, the synchronization policy manager 108 may use, e.g., (but not limited to) frequency of task synchronization as an indication of priority of a synchronization task 110. A synchronization task 110 that executes frequently over time may be indicative of, e.g., (but not limited to) a dynamic data source, as compared to a data source that executes rarely. Probabilistically, in an exemplary embodiment, it may make sense to prioritize the more dynamic data source ahead of the less dynamic source on an assumption that the former may be more likely to have changed than the latter, in the time since the last synchronization event.

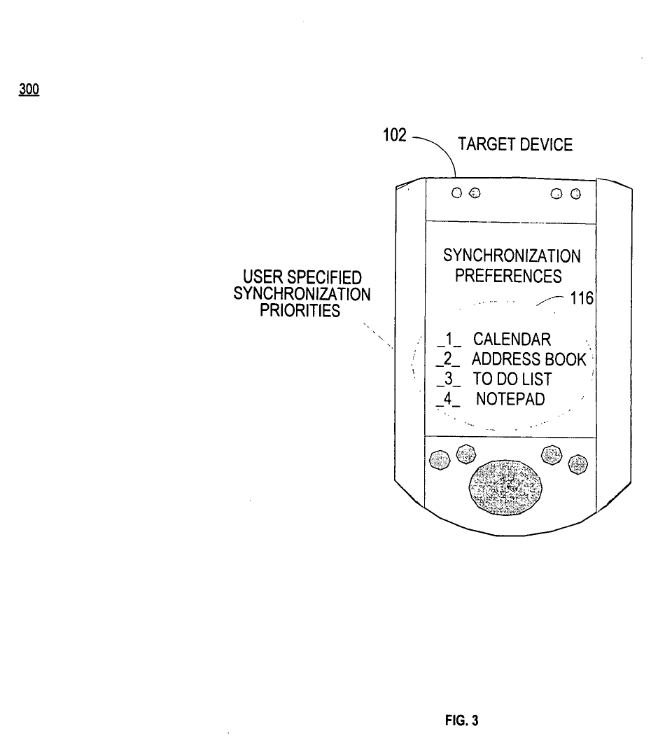

The synchronization policy manager 108, may also accept, e.g., (but not limited to) explicit user priority specifications 116 to set the priorities of the synchronization tasks 110. FIG. 3 depicts a diagram 300 illustrating an exemplary embodiment of a mobile device 102 having a graphical user interface (GUI) displaying an initial list of relative priorities among a list of exemplary synchronization tasks 110. As shown, the user may be able to specify by renumbering each synchronization task 110 on the list into a new order as defined by user-specified synchronization priorities 116.

The synchronization policy manager 108, as noted above, may also use a combination of application usage data 114 and user specified priorities 116 to set task priorities. In an exemplary embodiment, the synchronization policy manager 108 may schedule an order of execution of synchronization tasks by classifying different categories of synchronization tasks and then selecting in order of highest priority a schedule according to a prioritization process such as, e.g., (but not limited to) hierarchical class based prioritization (HCBP), weighted fair queuing (WFQ), or any of a number of other well known queuing and scheduling methods, etc.

In an exemplary embodiment, the synchronization policy manager 108 may order a queue of synchronization tasks 110 in order ranked by synchronization priorities.

FIG. 2 illustrates an exemplary embodiment of a flow diagram 200 of an exemplary embodiment of a synchronization method of an embodiment of the present invention. The following description may also refer to elements shown in FIG. 1. In an exemplary embodiment, flow diagram 200 may begin at 202 and may continue at 204 to determine whether mobile device 102 may be in range of base device 104. This may happen by any of a number of conventional handshaking methods including, e.g., (but not limited to) periodic polling, carrier sensing, or interrupting so as to identify that the devices 102, 104 may be within range, etc. When in range, flow diagram 200 may initiate a synchronization session by continuing with 206. At 206, the method, in an exemplary embodiment, may determine whether a previous synchronization session state 118 was stored, and if so may resume the interrupted synchronization session stored by retrieving the session from storage in, e.g., (but not limited to) synchronization task database 112. Initially, if no previous synchronization session was stored, or if a threshhold amount of time has passed since a stored synchronization session, then a new synchronization session may be initiated. Alternatively, in another exemplary embodiment of the invention, if a previous synchronization session was interrupted, processing may vary depending on the length of time elapsed since the interruption. For example, if a considerable length of time has passed since interruption, say, e.g., (but not limited to) in excess of a day, then synchronization may begin again with the highest priority. On the other hand, if synchronization resumes after only a brief interruption of, e.g., (but not limited to) where only a few minutes have elapsed, then the synchronization session may resume from where it was previously interrupted. In an exemplary embodiment, these features and associated thresholds may be user-configurable. From 206, flow diagram 200 may proceed to 206 to determine if there may be synchronization tasks 110 to be synchronized. Determination 206 may be performed by the synchronization session manager 106 and may include, e.g., (but not limited to) querying the synchronization task database 112 for any synchronization tasks 110 to synchronize. If no tasks 110 remain, then the synchronization session may be complete and flow diagram 200 may end at 212. If there may be synchronization tasks 110 to synchronize, then flow diagram 200 may proceed to 210 to determine whether the mobile device 102 may be still in communication with the base device 104. If devices 102, 104 are no longer in communication, then flow diagram 200 may continue with 214 to store the synchronization state 118 in, e.g., (but not limited to) the synchronization task database 112, and flow diagram 200 may proceed to interrupt the synchronization session at 220. As noted above with reference to 206, upon the mobile device 102 returning to the range of base device 104, the interrupted session 220 may resume by retrieving from storage the synchronization session state information 118 stored in 214. If the mobile and base devices are determined to still be in communication at 210, then the flow diagram 200 may continue with 216 where synchronization policy manager 108 may select the highest priority synchronization task 110 from a queue of synchronization tasks 110 stored in synchronization task database 112. From 216, flow diagram 200 may continue with 218, where synchronization session manager 106 may execute the synchronization task 110 chosen by the synchronization policy manager 108 in 216. From 218, flow diagram 200 may determine at 220 whether the entire synchronization task 110 was completely executed. For example, an acknowledgement may be sent upon completion of the synchronization, then in the absence of receipt of an acknowledgement, completion of synchronization may be deemed incomplete. At 220, if the execution of the synchronization task 110 may be deemed completed, then flow diagram 220 may continue with 222 to remove the completed task from the queue of synchronization tasks to be completed. If instead the execution of the synchronization task 110 may be deemed not to have been completed, then flow diagram 220 may continue with 224 to leave the incomplete synchronization task 110 in the queue of synchronization tasks to be completed, which may be completed upon the next time that the mobile device 102 comes within range, in resumption of a session in 206. In an exemplary embodiment, if the resumed session starts momentarily following after the previously interrupted session, then the synchronization session may continue on where it was left off. On the other hand, if the resumed session started some extended period of time after the interrupted session, then rather than resuming, the session may instead revert to executing the highest priority task. Alternatively, the system may be configured so as to, e.g., always revert to the highest priority task. Following 222 or 224, flow diagram 200 may continue with 208 to determine whether any additional tasks remain to be synchronized. The process of flow diagram 200 may continue to cycle until, e.g., (but not limited to) either there are no more items to synchronize at 208, or until the mobile device 102 may be no longer in communication with the base device 104, and the session may be interrupted at 220, etc.

In an exemplary embodiment, the synchronization session manager 106 may operate so as to maintain a synchronization state 118. If the mobile device 102 and base device 104 go out of range of one another, in an exemplary embodiment, the synchronization session state 118 may be stored along with synchronization tasks remaining to be completed. Upon the mobile device 102 and base device 104 returning to being within the range of one another, then the state of synchronization 118 may be retrieved, and remaining synchronization tasks 110 in the queue may then be executed by synchronization session manager 106 in priority order as determined by synchronization policy manager 108.

In an exemplary embodiment, different items of the same synchronization task 110 may have different subpriorities. For example, (but not limited to) items within a to-do list might be prioritized according to due date. Within the to-do list synchronization task, the to-do list items with the nearest due date might be synchronized first.

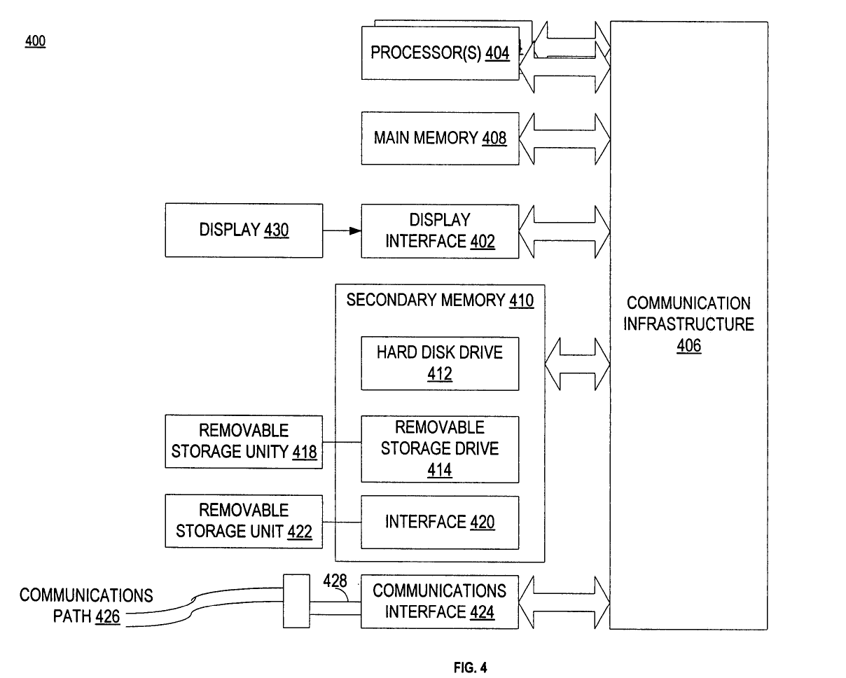

FIG. 4 depicts an exemplary embodiment of a computer system that may be used as, e.g., (but not limited to) mobile device 102, or base device 104, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An exemplary computer system 400 is shown in FIG. 4, depicting an exemplary but not limiting embodiment of a block diagram of a computer system that may be useful for implementing the present invention. Specifically, FIG. 4 illustrates computer system 400, which in an exemplary embodiment may be, but is not limited to, a personal computer (PC) system running an operating system such as, e.g., (but not limited to) WINDOWS MOBILE™ for POCKET PC, or MICROSOFT® WINDOWS® NT/98/2000/XP/etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. Other components of the invention, such as, e.g., (but not limited to) a computing device, a communications device, a telephone, a personal digital assistant (PDA), a handheld personal computer PC, a subnotebook PC, a notebook PC, a laptop PC, a desktop PC, network appliances, workstations, thin clients, fat clients, proxy servers, network communication servers, remote access devices, client computers, server computers, routers, web servers, data, media, audio, video, telephony or streaming technology servers, etc., may also be implemented using a computer such as that shown in FIG. 4.

The computer system 400 may include one or more processors, such as, e.g., processors 404. The processor(s) 404 may be coupled to a communication infrastructure 406 (e.g., a communications bus, cross-over bar, or network). Various software embodiments may be described in terms of this exemplary computer system. After reading this description, it will become apparent to a person skilled in the relevant art(s) how to implement the invention using other computer systems and/or architectures.

Computer system 400 may include a display interface 402 that forwards, e.g., (but not limited to) graphics, text, and other data, etc. from the communication infrastructure 406 (or from a frame buffer not shown) for display on the display unit 430.

The computer system 400 may also include, e.g., (but not limited to) a main memory 408, preferably random access memory (RAM), and a secondary memory 410, etc. The secondary memory 410 may include, for example, (but not limited to) a hard disk drive 412 and/or a removable storage drive 414, representing a floppy diskette drive, a magnetic tape drive, an optical disk drive, a compact disk drive CD-ROM, etc. The removable storage drive 414 may read from and/or write to a removable storage unit 418 in a well known manner. Removable storage unit 418, also called a program storage device, machine readable medium, or a computer program product, may represent, e.g., (but not limited to) a floppy disk, magnetic tape, optical disk, compact disk, etc., which may be read from and written to by removable storage drive 414. As will be appreciated, the removable storage unit 418 may include a computer usable storage medium having stored therein computer software and/or data. For example, the machine-readable medium may include flash memory devices; electrical, optical, acoustical or other form of propagated signals (e.g., carrier waves, infrared signals, digital signals, etc.), and others.

In alternative exemplary embodiments, secondary memory 410 may include other similar devices for allowing computer programs or other instructions to be loaded into computer system 400. Such devices may include, for example, (but not limited to) a removable storage unit 422 and an interface 420. Examples of such may include a program cartridge and cartridge interface (such as, e.g., those found in video game devices), a removable memory chip (such as, e.g., an erasable programmable read only memory (EPROM), or programmable read only memory (PROM) and associated socket), and other removable storage units 422 and interfaces 420, etc., which may allow software and data to be transferred from the removable storage unit 422 to computer system 400.

Computer 400 may also include an input device such as, e.g., (but not limited to) a mouse or other pointing device such as a digitizer, and a keyboard or other data entry device, etc. (none of which are labeled).

Computer 400 may also include output devices, such as, e.g., (but not limited to) display 430, and display interface 402, etc. Computer 400 may include input/output (I/O) devices such as, e.g., communications interface 424, cable 428 and communications path 426. These may include, e.g., a network interface card, and modems (neither are labeled). Communications interface 424 may allow software and data to be transferred between computer system 400 and external devices. Examples of communications interface 424 may include, e.g., (but not limited to) a modem, a network interface (such as, e.g., an Ethernet card), a communications port, a Personal Computer Memory Card International Association (PCMCIA) slot and card, etc. Software and data transferred via communications interface 424 may be in the form of signals 428 which may be electronic, electromagnetic, optical or other signals capable of being received by communications interface 424. These signals 428 may be provided to communications interface 424 via a communications path (e.g., channel) 426. This channel 426 may carry signals 428 and may be implemented using, e.g., (but not limited to) wire or cable, fiber optics, a telephone line, a cellular link, a radio frequency (RF) link and other communications channels, etc.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In this document, the terms “computer program medium” and “computer readable medium” may be used to generally refer to media such as, e.g., removable storage drive 414, a hard disk installed in hard disk drive 412, and signals 428. These computer program products provide software to computer system 400. The invention may be directed to such computer program products.

Computer programs (also called computer control logic), including object oriented computer programs, may be stored in main memory 408 and/or the secondary memory 410 and/or removable storage units 414, also called computer program products. Such computer programs, when executed, may enable the computer system 400 to perform the features of the present invention as discussed herein. In particular, the computer programs, when executed, may enable the processor 404 to perform the features of the present invention. Accordingly, such computer programs may represent controllers of the computer system 400.

In another exemplary embodiment, the invention may be directed to a computer program product comprising a computer readable medium having control logic (computer software) stored therein. The control logic, when executed by the processor 404, may cause the processor 404 to perform the functions of the invention as described herein. In another exemplary embodiment where the invention may be implemented using software, the software may be stored in a computer program product and loaded into computer system 400 using removable storage drive 414, hard drive 412 or communications interface 424. The control logic (software), when executed by the processor 404, may cause the processor 404 to perform the functions of the invention as described herein. The computer software may run as a standalone software application program running atop an operating system, or may be integrated into the operating system.

In yet another exemplary embodiment, the invention may be implemented primarily in hardware using, for example, hardware components such as application specific integrated circuits (ASICs), or one or more state machines. Implementation of the hardware state machine to perform the functions described herein will be apparent to persons skilled in the relevant art(s). In another exemplary embodiment, the invention may be implemented in firmware. In yet another exemplary embodiment, the invention may be implemented using a combination of any of hardware, firmware and software.

Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer).

The exemplary embodiment of the present invention makes reference to wireless personal area networks. A brief discussion of various exemplary wireless network technologies that might be used to implement the exemplary embodiments of the present invention may now be discussed. Exemplary wireless network technology types, may include, e.g., (but not limited to) IrDA wireless technology, and various wireless radio frequency (RF) technologies such as, e.g., short-range RF technologies, Bluetooth, SWAP, wireless fidelity (Wi-Fi), or other IEEE standard 802.11 wireless LANs, and ultrawideband (UWB), etc.

Infrared Data Association (IrDA) is a standard method for devices to communicate using infrared light pulses. Since IrDA devices use infrared light, they may depend on being in line of sight with each other.

Bluetooth is an example of a short-range wireless radio frequency (RF) emerging wireless technology promising to unify several wireless technologies for use in low power radio frequency (RF) networks.

Examples of other short-range wireless RF technologies may include, e.g., (but not limited to) shared wireless access protocol (SWAP) developed by Home radio frequency (HomeRF), and wireless fidelity (Wi-Fi), a derivative of IEEE 802.11, advocated by the wireless ethernet compatibility alliance (WECA), etc.

The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., wireless LANs compliant with IEEE std. 802.11a, b, d or g, such as, e.g., (but not limited to) of version IEEE Std 802.11, 1999 Edition; or IEEE Std 802.11a-1999, IEEE Std 802.11b-1999, IEEE Std 802.11b-1999/Cor 1-2001, IEEE Std 802.11d-2001, IEEE Std 802.11-1999 (R2003), and/ or IEEE 802.11g-2003, etc.

Another exemplary short-range RF wireless communication system is UWB. UWB may use small pulses of energy in the time domain that in the frequency domain may be spread across a very wide bandwidth and may be transmitted at a very low power level that is on the order of noise. The pulses may be encoded to carry information by, e.g., differing the timing of arrival of pulses in the time domain.

While embodiments of the invention have been described above using such terms as “base” and “mobile,” it is to be understood that the invention is not limited to any particular communication and/or computing devices. Additionally, such devices may be stationary or mobile.

While various exemplary embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1. A method, comprising:
receiving at least one synchronization priority assignment for each of at least two synchronization tasks of a synchronization session between a first device and a second device; and
executing said at least two synchronization tasks in order from a highest to a lowest synchronization priority.

2. The method according to claim 1, wherein said at least one synchronization priority assignment is based on at least one of: an explicit factor; an implicit factor; a specified priority; an application usage based priority; and an application usage based priority assigned based on determining a frequency of use of an application associated with each of said at least two synchronization tasks.

3. The method according to claim 1, further comprising:
initiating said synchronization session when said first device and said second device are within range of one another.

4. The method according to claim 1, further comprising:
determining whether one of said at least two synchronization tasks completely executed, and
placing said one of said at least two synchronization tasks into a queue of at least one of said at least two synchronization tasks remaining to be executed, if said one of said at least two synchronization tasks is determined not to have been completely executed.

5. The method according to claim 1, further comprising:
maintaining a state of synchronization in the event of said first device and said second device falling outside range of one another, and
continuing said synchronization session executing at least one of said at least two synchronization tasks in said order of priority upon said first device and said second device returning within range of one another.

6. A system, comprising:
a first device having first data adapted to be in communication with a second device having second data;
at least two synchronization tasks adapted to synchronize said first data with said second data, each of said at least two synchronization tasks having at least one synchronization priority;
a synchronization policy manager adapted to assign said at least one synchronization priority to each of said at least two synchronization tasks, said synchronization policy manager comprising a synchronization task database adapted to store said at least two synchronization tasks, and a queue of said at least two synchronization tasks in order of said at least one synchronization priority; and
a synchronization session manager adapted to execute said at least one of said at least two synchronization tasks in order of said at least one synchronization priority of said queue.

7. The system according to claim 6, wherein said synchronization policy manager comprises: an assignment of synchronization priority based on at least one of: an explicit factor and an implicit factor.

8. The system according to claim 7, wherein said explicit factor comprises a specified priority.

9. The system according to claim 7, wherein said implicit factor comprises an application usage based priority.

10. The system according to claim 9, wherein said application usage based priority comprises an assignment based on frequency of use of an application associated with said at least two synchronization tasks.

11. The system according to claim 6, wherein at least one of said first device and said second device comprises at least one of:
a computing device;
a communications device;
a personal computer (PC);
a personal digital assistant (PDA);
a handheld PC;
a notebook PC;
a subnotebook PC;
a laptop PC;
a tablet PC;
a server;
a workstation; and
a phone.

12. The system according to claim 6, wherein at least one of said first device and said second device comprise a wireless device.

13. The system according to claim 12, wherein said wireless device comprises at least one of:
an Infrared Data Association (IrDA)-compliant wireless device;
a short-range radio frequency technology wireless device;
a Bluetooth-compliant wireless device;
an IEEE 802.11 standard-compliant wireless local area network (LAN) device;
a shared wireless access protocol (SWAP)-compliant wireless device;
a wireless fidelity (Wi-Fi)-compliant wireless device; and
an ultrawideband (UWB) wireless device.

14. The system according to claim 6, wherein said synchronization policy manager comprises a prompt adapted to receive said at least one synchronization priority from at least one of said first device and said second device.

15. The system according to claim 6, wherein said synchronization session manager is adapted to initiate a synchronization session when said first device and said second device are within range of one another.

16. The system according to claim 6, wherein said synchronization session manager is adapted to execute said at least two synchronization tasks while said first device and said second device remain within range of one another.

17. The system according to claim 6, further comprising:
a detector adapted to determine whether said one of said at least two synchronization tasks completely executed, and to place said one of said at least two synchronization tasks into said queue if said at least two synchronization tasks did not completely execute.

18. The system according to claim 6, further comprising:
a state manager adapted to maintain a state of synchronization in the event of said first device and said second device falling outside range of one another, and to cause said synchronization session manager to again execute at least one of said at least two synchronization tasks remaining at said state of synchronization upon said first device and said second device returning within range of one another.

19. The system of claim 6, wherein said synchronization policy manager is adapted to assign at least one synchronization priority based on a frequency of use by a user of an application associated with each of said at least two synchronization tasks.

20. The system of claim 6, wherein at least one of said at least two synchronization tasks comprises at least one subtask having a sub-priority.

21. A machine-readable medium that provides instructions, which when executed by a computing platform, cause said computing platform to perform operations comprising a method of:
receiving at least one synchronization priority assignment for each of at least two synchronization tasks of a synchronization session between a first device and a second device; and
executing said at least two synchronization tasks in order from a highest to a lowest synchronization priority.

22. The machine-readable medium according to claim 21, wherein said one synchronization priority assignment is based on at least one of: an explicit factor and an implicit factor.

23. The machine-readable medium according to claim 22, wherein said explicit factor comprises a specified priority.

24. The machine-readable medium according to claim 22, wherein said implicit factor comprises an application usage based priority.

25. The machine-readable medium according to claim 24, wherein said application usage based priority is assigned based on determining a frequency of use of an application associated with each of said at least two synchronization tasks.

26. The machine-readable medium according to claim 21, wherein said receiving comprises:
receiving said at least one synchronization priority assignment at at least one of said first device and said second device.

27. The machine-readable medium according to claim 21, wherein the method further comprises:
initiating said synchronization session when said first device and said second device are within range of one another.

28. The machine-readable medium according to claim 27, wherein said executing comprises:
executing at least one of said at least two synchronization tasks while said first device and said second device remain within range of one another.

29. The machine-readable medium according to claim 21, further comprising:
determining whether one of said at least two synchronization tasks completely executed, and
placing said one of said at least two synchronization tasks into a queue of at least one of said at least two synchronization tasks remaining to be executed, if said one of said at least two synchronization tasks is determined not to have been completely executed.

30. The machine-readable medium according to claim 21, further comprising:
maintaining a state of synchronization in the event of said first device and said second device falling outside range of one another, and
continuing said synchronization session executing at least one of said at least two synchronization tasks in said order of priority upon said first device and said second device returning within range of one another.
